(19) United States
(12) Patent Application Publication
(10) Pub. No.: US 2015/0222679 A1
(43) Pub. Date: Aug. 6, 2015

(54) DATA STREAMING FRAMEWORK FROM DATABASE TO MULTIPLE TARGETS BY LEVERAGING CACHED DATABASE CONNECTIONS AND CURSORS

(71) Applicant: Wal-Mart Stores, Inc., Bentonville, AR (US)

(72) Inventor: Deepu Bhatia, Carlsbad, CA (US)

(73) Assignee: Wal-Mart Stores, Inc., Bentonville, AR (US)

(21) Appl. No.: 14/170,292

(22) Filed: Jan. 31, 2014

(51) Int. Cl. H04L 29/06; H04L 29/08

(52) U.S. Cl. CPC H04L 65/60; H04L 67/2842

(57) ABSTRACT

Example systems and methods for streaming data from database using established pipelines are described. In one implementation, a method receives a request for data from a database. The method also determines a pipeline corresponding to the request, and then provide a data stream from the database using the determined pipeline.

### TECHNICAL FIELD

The present disclosure relates to methods and systems for streaming data from a database using cached database connections.

### BACKGROUND

Connecting to a database server typically includes several time-consuming steps. A physical channel (e.g., a socket) is established, the initial handshake with the server occurs, the connection is authenticated by the server, checks are run for enlisting in a transaction, etc. Database connections are expensive resources because the database connections take a long time to create/initialize and use a lot of memory as well as CPU time. However, applications generally use one or a few different configurations for database connections, and therefore, many identical connections are repeatedly opened and closed during application execution, therefore wasting resources.

### BRIEF DESCRIPTION OF THE DRAWINGS

Non-limiting and non-exhaustive embodiments of the present disclosure are described with reference to the following figures, wherein like reference numerals refer to like parts throughout the various figures unless otherwise specified.

FIG. 1 is a block diagram depicting a computing environment within which an example embodiment of the present disclosure may be implemented.

FIG. 2 is a block diagram depicting an embodiment of a computing device configured to implement systems and methods of the present disclosure.

FIG. 3 is a flowchart diagram of an embodiment of a process for streaming data from a database using cached database connections.

FIG. 4 is a flowchart diagram of an embodiment of a process for establishing a pipeline for streaming data from a database.

### DETAILED DESCRIPTION

In the following description, reference is made to the accompanying drawings that form a part thereof, and in which is shown by way of illustrating specific exemplary embodiments in which the disclosure may be practiced. These embodiments are described in sufficient detail to enable those skilled in the art to practice the concepts disclosed herein, and it is to be understood that modifications to the various disclosed embodiments may be made, and other embodiments may be utilized, without departing from the scope of the present disclosure. The following detailed description is, therefore, not to be taken in a limiting sense.

Reference throughout this specification to “one embodiment,” “an embodiment,” “one example,” or “an example” means that a particular feature, structure, or characteristic described in connection with the embodiment or example is included in at least one embodiment of the present disclosure. Thus, appearances of the phrases “in one embodiment,” “in an embodiment,” “one example,” or “an example” in various places throughout this specification are not necessarily all referring to the same embodiment or example. Furthermore, the particular features, structures, databases, or characteristics may be combined in any suitable combinations and/or sub-combinations in one or more embodiments or examples. In addition, it should be appreciated that the figures provided herewith are for explanation purposes to persons ordinarily skilled in the art and that the drawings are not necessarily drawn to scale.

Embodiments in accordance with the present disclosure may be embodied as an apparatus, method, or computer program product. Accordingly, the present disclosure may take the form of an entirely hardware-comprised embodiment, an entirely software-comprised embodiment (including firmware, resident software, micro-code, etc.), or an embodiment combining software and hardware aspects that may all generally be referred to herein as a “circuit,” “module,” or “system.” Furthermore, embodiments of the present disclosure may take the form of a computer program product embodied in any tangible medium of expression having computer-usable program code embodied in the medium.

Any combination of one or more computer-usable or computer-readable media may be utilized. For example, a computer-readable medium may include one or more of a portable computer diskette, a hard disk, a random access memory (RAM) device, a read-only memory (ROM) device, an erasable programmable read-only memory (EPROM or Flash memory) device, a portable compact disc read-only memory (CDROM), an optical storage device, and a magnetic storage device. Computer program code for carrying out operations of the present disclosure may be written in any combination of one or more programming languages. Such code may be compiled from source code to computer-readable assembly language or machine code suitable for the device or computer on which the code will be executed.

Embodiments may also be implemented in cloud computing environments. In this description and the following claims, “cloud computing” may be defined as a model for enabling ubiquitous, convenient, on-demand network access to a shared pool of configurable computing resources (e.g., networks, servers, storage, applications, and services) that can be rapidly provisioned via virtualization and released with minimal management effort or service provider interaction and then scaled accordingly. A cloud model can be composed of various characteristics (e.g., on-demand self-service, broad network access, resource pooling, rapid elasticity, and measured service), service models (e.g., Software as a Service (“SaaS”), Platform as a Service (“PaaS”), and Infrastructure as a Service (“IaaS”)), and deployment models (e.g., private cloud, community cloud, public cloud, and hybrid cloud).

The flow diagrams and block diagrams in the attached figures illustrate the architecture, functionality, and operation of possible implementations of systems, methods, and computer program products according to various embodiments of the present disclosure. In this regard, each block in the flow diagrams or block diagrams may represent a module, segment, or portion of code, which comprises one or more executable instructions for implementing the specified logical function(s). It will also be noted that each block of the block diagrams and/or flow diagrams, and combinations of blocks in the block diagrams and/or flow diagrams, may be implemented by special purpose hardware-based systems that perform the specified functions or acts, or combinations of special purpose hardware and computer instructions. These computer program instructions may also be stored in a computer-readable medium that can direct a computer or other programmable data processing apparatus to function in a particular manner, such that the instructions stored in the computer-readable medium produce an article of manufacture including instruction means which implement the function/act specified in the flow diagram and/or block diagram block or blocks.

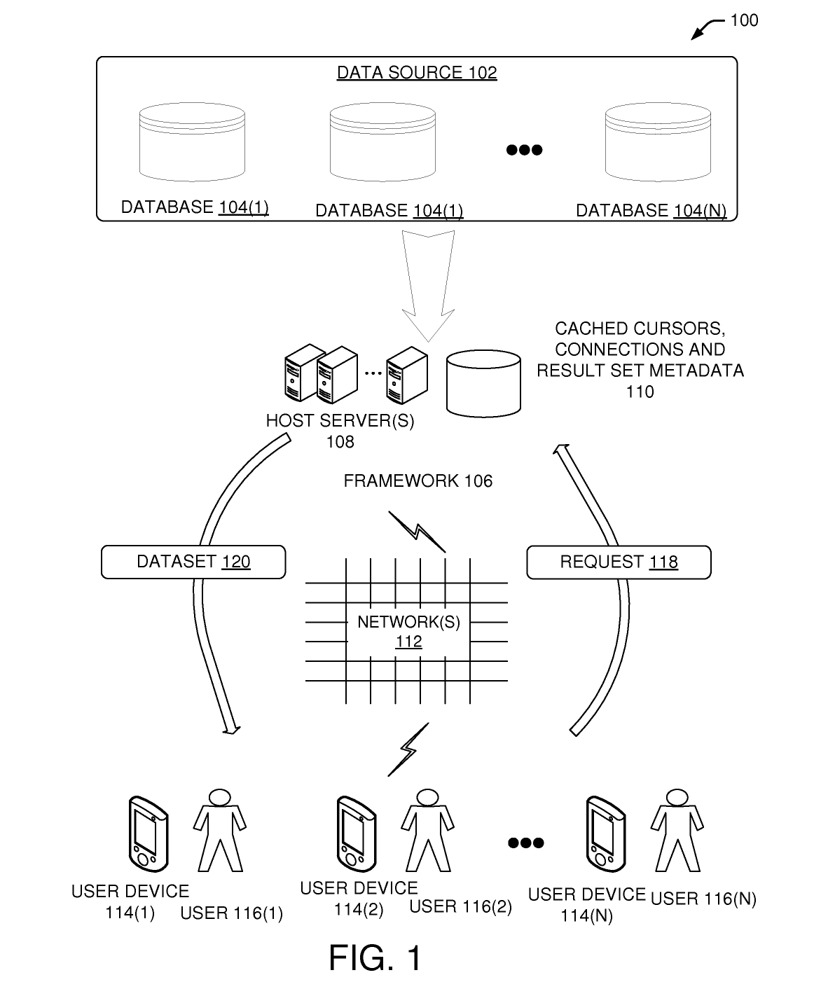

FIG. 1 is a block diagram depicting a computing environment 100 within which an example embodiment of the present disclosure may be implemented. Computing environment 100 includes a data source 102, for example, an ODBC (Open Database Connectivity) compliant data source, JDBC (Java Database Connectivity) compliant data source, etc. Data source 102 may include multiple databases (e.g., a database 104(1), a database 104(2), . . . , a database 104(n)). In some embodiments, data source 102 may be JDBC compliant data sources. Example of JDBC compliant data sources may include databases such as Microsoft® SQL server, Oracle®, MySQL®, and/or flat file databases.

Computing environment 100 also include a framework 106. Framework 106 may be deployed to its own cluster or incorporated into a computing system. Framework 106 may be implemented as a data streaming utility, which is easy to configure and pluggable. Framework 106 may allow users to continuously extract data from multiple homogeneous databases, by leveraging cached connections and cursors. Compared to conventional techniques, the design of framework 106 has advantages including, for example, simplicity, configurable SQL payload, configurable data sources, reducing typical overheads by caching connections, cursors, other tuning enhancements, result set manipulation through configurable plugins, ease of deployment, etc. In some embodiments, framework 106 may include one or more host server(s) 108 that provide one or more interfaces to define, configure, and/or manage connections to data source 102. Host server 108 may facilitate utilization of JDBC reflection to connect and/or interrogate data source 102, and provide an interface allowing an administrator and/or user to define information to be shared. In some embodiments, Java servlets may be used to generate the interface for naming and creating mapping data, wherein the mapping data can define the information to be shared and how it is shared. In some embodiments, host server 108 may be a server farm including a collection of computer servers.

Host server 108 may store data retrieved from one or more databases of database 104(1), database 104(2), . . . , database 104(n). Host server 108 is described in greater detail with reference to the following figures. Host server 108 may include or be associated with cached cursors, connections and result set metadata 110, which may include one or more pipelines. A pipeline may include one or more connection caches, one or more result set metadata caches, and/or one or more cursors caches. In some embodiments, a connection cache may be represented by a database instance and has an associated one or more cached connection configurations. A database instance may be a set of memory structures that manage database files. The instance manages its associated data and serves the users of the database. For the connection cache, the associated cached connection configurations may indicate physical connections (e.g., database connections) to the database and/or schema. A cached connection configuration may be created when a database connection is requested and is not in the connection cache.

In some embodiments, a result set metadata cache may include one or more result sets that are returned and cached in response to execution of a request (e.g., a SQL query) to a database. A result set may include a set of rows from the database and metadata about the query such as the column names, the types and sizes of each column. In some embodiments, a cursor cache may include one or more database cursors each corresponding to a result set that are returned in response to execution of a request to a database. A database cursor may be a control structure that enables traversal over the records in a database. Cursors facilitate subsequent processing in conjunction with the traversal, such as retrieval, addition and removal of database records.

Host server 108 may connect one or more network(s) 112 to exchange information with data source 102 and multiple user devices, e.g., a user device 114(1), a user device 114(2), . . . , a user device 114(n) that are associated with a user 116(1), a user 116(2), a user 116(n), respectively. Network(s) 112 may include wired and/or wireless networks that enable communications between the various computing devices described in environment 100. In some embodiments, network(s) 112 may include local area networks (LANs), wide area networks (WAN), mobile telephone networks (MTNs), and other types of networks, possibly used in conjunction with one another, to facilitate communication between the various computing devices (e.g., user devices 114, host server 108, and/or data source 102).

User devices 114 may be a mobile or desktop computer, a personal data assistant (PDA), an internet appliance, an internet enabled mobile phone, a server or any other computing device configured with a network connection.

In some embodiments, Host server 108 may receive a request 118 for data from data source 102, and then determine whether a pipeline corresponding to request 118 is available. The pipeline may include a connection cache that has a database connection configuration that has been created in response to one or more previous requests, and the database connection configuration indicates a database connection to the data in the database (e.g., database 104(1).

In some embodiments, host server 108 may parse a SQL statement overhead. The SQL statement parsing may include multiple phases such as, for example, a parsing phase, a binding phase, an executing phrase, a defining phase, and a fetching phase. The parsing phase may include checking syntax of a query, using dictionary for validating semantics, and/or searching shared pool for existing SQL statement with the same one or more harsh values. In response to no existing SQL statement being not found in the shared pool, host server 108 may create one or more execution plans for the query, and evaluate the one or more execution plans based on a cost-based decision tree. Host server 108 may then select a plan with the lowest cost. The binding phase may include gathering input parameters received from user devices 114. With database connections and cursors cached, the executing phase, the defining phase, and the fetching phase may take place. The executing phase may include running the execution plan. The defining phase may include defining output data format based on output parameters received form user devices 114. The fetching phase may include query execution and data fetching.

In response to a determination that the pipeline is not available, host server 108 may establish the pipeline based on the request. In some instances, host server 108 may transmit the request to data source 102 where the request is executed by, for example, database 104(1). Host server 108 may then retrieve a configuration of a database connection corresponding to the request. Host server 108 may also maintain the database connection open using, for example, the database connection configuration, and cache the database connection configuration after the database connection has been created.

In some instances, Host server 108 may retrieve a result set corresponding to the request and cache the result set in a result set metadata cache. In some instances, host server 108 may also retrieve a cursor corresponding to the cached result set, and store the cursor in a cursor cache. In some embodiments, the host server may determine that the pipeline is available. In these instances, host server 108 may retrieve data from data source 102 and provide a dataset 120 to user devices 114.

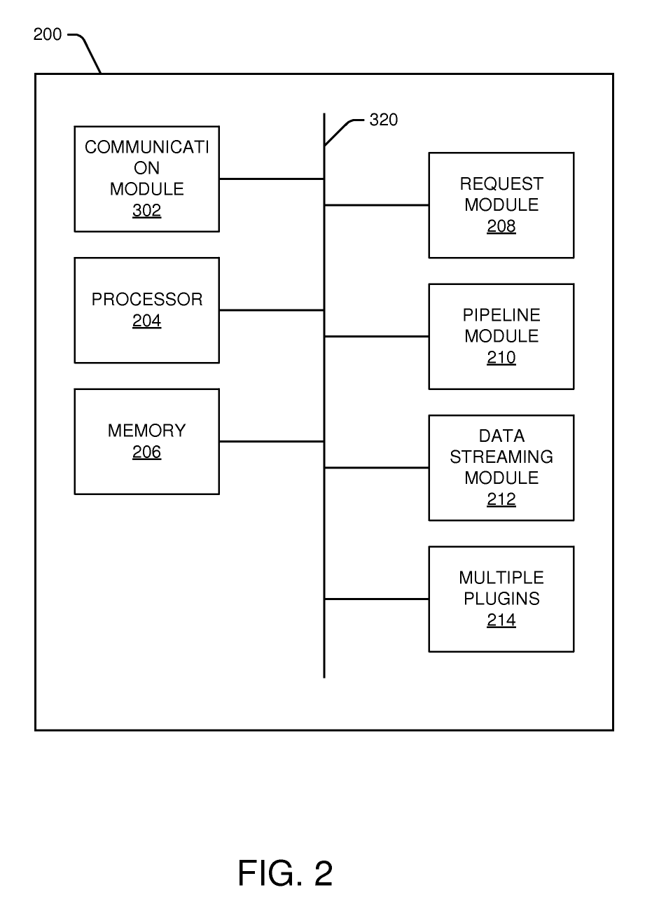

FIG. 2 is a block diagram depicting an embodiment of a computing device 200 configured to implement systems and methods of the present disclosure. Computing device 200 (e.g., host server 108) performs various functions related to resource allocation for infrastructure engineering, as discussed herein. In some embodiments, the computing devices 200 may include ones of computing devices that cooperatively implement the functions described herein. Computing device 200 includes a communication module 202, a processor 204, and a memory 206. Communication module 202 allows computing device 200 to communicate with other systems, such as communication networks, other servers, etc. Processor 204 executes one or more sets instructions to implement the functionality provided by computing device 200. Memory 206 stores these instructions as well as other data used by processor 204 and other modules contained in computing device 200.

Computing device 200 also includes a request module 208 configured to receive a request (e.g., request 118) for data from a database. The request may be expressed in the Structured Query Language (SQL). The SQL may include different versions, and a variety of extensions. For example, SQL data definition language (“DDL”) instructions are issued to a data base server to create or configure database objects, such as tables, views, or complex data types. For example, SQL/XML is an extension of SQL to manipulate XML data in an object-relational database.

Computing device may also include a pipeline module 210 configured to establish a pipeline corresponding to a database request as well as monitor and/or configure data generation with respect to the pipeline. In some embodiments, the pipeline module 210 may determine a pipeline corresponding to the request. The pipeline may include a connection cache that has a database connection configuration that has been created in response to one or more previous requests, and the database connection configuration indicates a database connection to the data in the database. The pipeline may maintain the database connection open, and cache the database connection configuration after the database connection has been established in response to the one or more previous requests.

In some embodiments, the pipeline may include a result set metadata cache and/or a cursor cache. In these instances, the result set metadata cache may include one or more result sets that are returned and stored in response to execution of a query to a database. A result set may include a set of rows from the database and metadata about the query such as the column names, the types and sizes of each column. The cursor cache may include one or more database cursors each corresponding to a result set that are returned in response to execution of a query to a database.

In some embodiments, pipeline module 210 determine that the pipeline is not available. For example, the pipeline module determine that the database connection corresponding to the request is not available. Pipeline module 210 may establish the pipeline corresponding to the request. In some instances, the pipeline module may retrieve and cache a configuration of the database connection corresponding to the request after execution of the request by the database. Pipeline module 210 may cache the result set that is returned in response to the execution of the request and cursor corresponding to the returned result set.

Computing device 200 may also include a data streaming module 212 configured to provide a data stream (e.g., dataset 120) from data source 102 using the determined pipeline. In some embodiments, data streaming module 212 may provide the data as data stack using a Round-Robin algorithm. Round-robin algorithm may be employed by processes and network schedulers in computing. For example, time slices may be assigned to each process in equal portions and in circular order, and the processes may be handled in the form of cyclic executive.

Computing device 200 may also include multiple plugins 214 that are configurable to facilitate various data transformation for different business goals (e.g., monitoring database activities, retrieving real-time transaction data, etc.) when the data go through a pipeline. In some embodiments, the multiple plugins may transform the single dataset retrieved from data source 102 using a determined pipeline into one or more datasets (e.g., dataset 120) that are desired by users 116. In some instances, the transformation may be implemented within a single extraction from data source 102.

In some embodiments, the datasets may be transmitted to a user interface. In some instances, the user interface may be a real-time user interface that shows a graphical presentation of the current status (e.g., snapshot) and historical trends of an organization's key performance indicators to enable instantaneous and informed decisions to be made at a glance. The content of the user interface may be updated to reflect the most current information in data source 102, the items of the user interface may have its own access list. Accordingly, a developer may create, copy, and paste these items.

Advantageously, computing device 200 provides multiple session level optimizations and settings, and allows developers to leverage additional database settings, such as sort area memory, degree of parallelism, time zone support, date formats, etc. Computing device 200 may also facilitate result set sizing. For example, embodiments of the present disclosure allow developers to tune the size of a result set returned by data source 102, and therefore allows users 116 to minimize a number of round trips between framework 106 and data source 102. For example, an execution of request 118 returns 1000 rows, and the default size of a result set is 100, which means users 116 need to do 10 round trips in order to extract the full dataset. By changing the result set size to 1000, users 116 may extract the result set in a single round trip, therefore reducing network chattiness dramatically.

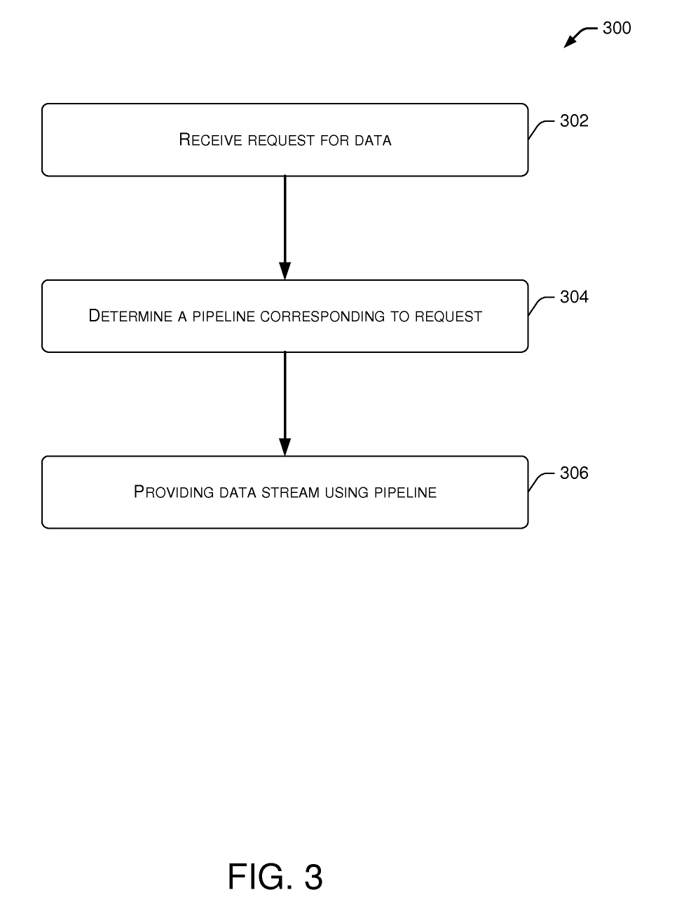

FIG. 3 is a flowchart diagram of an embodiment of a process 300 for streaming data from a database using cached database connections. Example process 300 includes one or more operations, actions, or functions. Although illustrated as discrete blocks, various blocks may be divided into additional blocks, combined into fewer blocks, or eliminated, depending on the desired implementation. Process 300 may be implemented by one or more processors including, for example, the computing device 200. For illustrative purposes, the operations described below are performed by a processor of the computing device as shown in FIG. 2.

At 302, request module 208 may receive a request for data from data source 102. At 304, pipeline module 210 may determine a pipeline corresponding to the request. The pipeline may include a connection cache that has a database connection configuration that has been created in response to one or more previous requests, and the database connection configuration may indicate a database connection to the data in the database.

In some embodiments, pipeline module 210 may maintain the database connection open, and cache the database connection configuration after the database connection has been established in response to the one or more previous requests.

In some embodiments, the pipeline may include a result set metadata cache that includes one or more result sets that are returned and cached in response to the one or more previous requests. In these instances, the pipeline may include a cursor cache that includes one or more database cursors each corresponding to a result set of the one or more result sets.

At 304, computing device 200 may provide the data from the database using the determined pipeline. In some embodiments, computing device 200 may provide a data stream using a Round-Robin algorithm, and transmit a dataset associated with the data stream to one or more plugins. In these instances, computing device 200 may also facilitate multiple transformations of the data for one or more targets associated with, for example, database activity monitoring, real-time retrievals, etc.

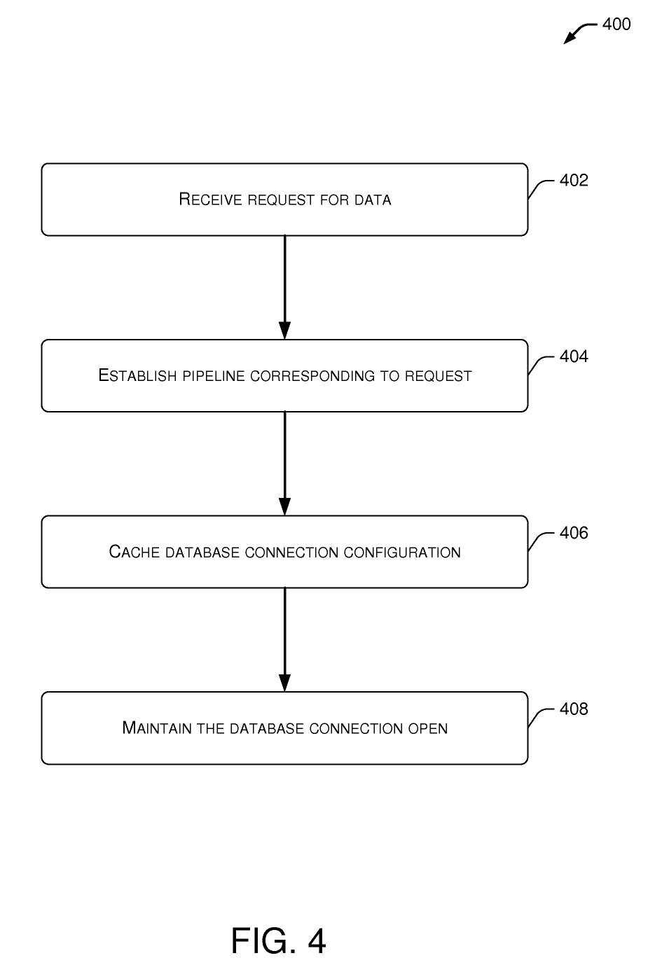

FIG. 4 is a flowchart diagram of an embodiment of a process 400 for establishing a pipeline for streaming data from a database. At 402, the request module 208 may receive a request for data from data source 102. At 404, pipeline module 210 may establish a pipeline in response to a determination that a database connection corresponding to the request is not available.

In some embodiments, the pipeline may include a connection cache that has a database connection configuration that is created in response to the request, and the database connection configuration may indicate a database connection to the data in the database. In some embodiments, the pipeline may also include a result set metadata cache that includes one or more result sets that are returned and cached in response to the request, and a cursor cache that includes one or more database cursors each corresponding to a result set of the one or more result sets.

At 406, pipeline module 210 may cache the database connection configuration of the database connection. At 408, pipeline module 201 may maintain the database connection open to facilitate data streaming from the database.

In some embodiments, request module 208 may receive an additional request for the data from the database. In these instances, pipeline module 210 may determine the pipeline corresponding to the additional request, and data streaming module 212 may provide a data stream from the database using the determined pipeline.

Although the present disclosure is described in terms of certain preferred embodiments, other embodiments will be apparent to those of ordinary skill in the art, given the benefit of this disclosure, including embodiments that do not provide all of the benefits and features set forth herein, which are also within the scope of this disclosure. It is to be understood that other embodiments may be utilized, without departing from the scope of the present disclosure.

1. A method comprising:
receiving, by one or more processors, a request for data from a database;
determining a pipeline corresponding to the request, the pipeline including a connection cache that has a database connection configuration that has been created in response to one or more previous requests, the database connection configuration indicating a database connection to the data in the database; and
providing a data stream from the database using the determined pipeline.

2. The method of claim 1, further comprising:
maintaining the database connection open; and
caching the database connection configuration after the database connection has been established in response to the one or more previous requests.

3. The method of claim 1, wherein the pipeline comprises a result set metadata cache that includes one or more result sets that are returned and cached in response to the one or more previous requests.

4. The method of claim 3, wherein the pipeline comprises a cursor cache that includes one or more database cursors each corresponding to a result set of the one or more result sets.

5. The method of claim 1, wherein the providing the data stream from the database using the determined pipeline comprises executing the request using the database connection.

6. The method of claim 1, wherein the providing the data stream comprises providing the data stream using a Round-Robin algorithm.

7. The method of claim 1, wherein the providing the data stream from the database using the determined pipeline comprises transmitting a dataset associated with the data stream to one or more plugins.

8. The method of claim 1, further comprising:
facilitating multiple transformations of the data for one or more targets associated with database activity monitoring.

9. A method comprising:
receiving, by one or more processors, a request for data from a database;
establishing a pipeline corresponding to the request, the pipeline including a connection cache that has a database connection configuration that is created in response to the request, the database connection configuration indicating a database connection to the data in the database;
caching the database connection configuration of the database connection; and
maintaining the database connection open to facilitate data streaming from the database.

10. The method of claim 9, wherein the pipeline comprises a result set metadata cache that includes one or more result sets that are returned and cached in response to the request.

11. The method of claim 10, wherein the pipeline comprises a cursor cache that includes one or more database cursors each corresponding to a result set of the one or more result sets.

12. The method of claim 9, further comprising:
receiving an additional request for the data from the database;
determining the pipeline corresponding to the additional request; and
providing a data stream from the database using the determined pipeline.

13. The method of claim 12, wherein the providing the data stream from the database using the determined pipeline comprises executing the request using the database connection.

14. The method of claim 12, wherein the providing the data stream comprises providing the data stream using a Round-Robin algorithm.

15. The method of claim 1, wherein the providing the data stream from the database using the determined pipeline comprises transmitting a dataset associated with the data stream to one or more plugins.

16. An apparatus comprising:
a memory configured to store data and one or more sets of instructions; and
one or more processors coupled to the memory, the one or more processors configured to execute the one or more sets of instructions and perform operations comprising:
receiving, by one or more processors, a request for data from a database;
determining a pipeline corresponding to the request, the pipeline including a connection cache that has a database connection configuration that has been created in response to one or more previous requests, the database connection configuration indicating a database connection to the database; and
providing a data stream from the database using the determined pipeline.

17. The apparatus of claim 16, wherein the operations further comprise:
maintaining the database connection open; and
caching the database connection configuration after the database connection has been established in response to the one or more previous requests

18. The apparatus of claim 16, wherein the pipeline comprises a result set metadata cache that includes one or more result sets that are returned and cached in response to the one or more previous requests.

19. The apparatus of claim 17, wherein the pipeline comprises a cursor cache that includes one or more database cursors each corresponding to a result set of the one or more result sets.

20. The apparatus of claim 16, wherein the providing the data stream from the database using the determined pipeline comprises transmitting a dataset associated with the data stream to one or more plugins.
